(19) United States
(12) Patent Application Publication
(10) Pub. No.: US 2022/0415297 A1
(43) Pub. Date: Dec. 29, 2022

(54) SOUND INSULATION DEVICE

(71) Applicants: BASF SE, Ludwigshafen am Rhein (DE); Massachusetts Institute of Technology, Cambridge, MA (US)

(72) Inventors: Ralf NOERENBERG, Mannheim (DE); Nabarun Roy, Wyandotte, MI (US); Shahrzad Ghaffari Mosanenzadeh, Cambridge, MA (US); Nicholas Xuanlai Fang, Cambridge, MA (US)

(73) Assignees: BASF SE, Ludwigshafen am Rhein (DE); Massachusetts Institute of Technology, Cambridge, MA (US)

(21) Appl. No.: 17/756,179

(22) PCT Filed: Nov. 20, 2020
(86) PCT No.: PCT/EP2020/082875

§ 371 Date: May 18, 2022

(30) Foreign Application Priority Data
Nov. 22, 2019 (EP) 19210890.0

(51) Int. Cl. G10K 11/162; G10K 11/172

(52) U.S. Cl. CPC G10K 11/162; G10K 11/172

(57) ABSTRACT

A sound insulation device contains at least one rigid support element and at least one elastic membrane element. The rigid support element contains at least one support grid containing a plurality of cells. The elastic membrane element is arranged on the support grid. The sound insulation device is configured to block at least partially acoustic energy transmission at a frequency range of 60 Hz to 500 Hz. The sound insulation device exhibits a negative effective mass below a resonance frequency, where the resonance frequency is given by:

$${ω}_{0} = \frac{4 π δ}{A} \sqrt{\frac{E}{ρ ( 1 - {ϑ}^{2} )}} ,$$

where A is a pore size of the support grid spun by the membrane element, δ is a thickness of the membrane element, E is an elastic modulus of the membrane element, ρ is a density of the membrane element, and ϑ is a Poisson ratio of the membrane element. The elastic modulus E of the membrane element is ≥8 MPa.

### FIELD OF THE INVENTION

The invention relates to a sound insulation device and a manufacturing method for manufacturing at least one sound insulation device. The invention further relates to various uses of the sound insulation device. The devices, methods and uses according to the present invention specifically may be employed for example in various areas such as in construction industry, building isolation such as dampening of rooms, traffic acoustic such as of tires or streets. However, other applications are also possible.

### BACKGROUND

Sound waves generally are longitudinal pressure waves. An incident sound wave impinging on a structure such as a wall can be reflected, scattered, absorbed or transmitted by the structure. Specifically, the incident sound wave is propagated within the structure when the resonant density fluctuations in the structure material do not excite the surface of the structure to vibrate; the incident sound wave is transmitted when the structure material starts to vibrate and does not dissipate the energy of the waves; the incident sound wave is reflected when the structure material cannot vibrate at the frequency of the waves; and the incident sound wave is absorbed when the structure material starts to vibrate and quickly dissipates the energy of the waves. Several properties of the structure can influence behavior of sound waves such as mass, stiffness, porosity and the like. For homogenous materials sound transmission can be described by the so-called mass law of sound insulation.

The mass law describes that frequency dependence of noise absorption is higher at high frequencies that at low frequencies. In order to cope with the higher demand for good noise absorption in modern buildings, the building elements need to be heavier. On the other side, the trend for fast and resource conserving construction demands for light-weight solutions. Therefore, there has been considerable effort in the past years to find new ways for noise blocking with structured materials, so called acoustic metamaterials.

A large number of sound insulation devices are known from the prior art. For example, U.S. Pat. No. 8,579,073 B2 describes an acoustic energy absorption metamaterial which includes at least one enclosed planar frame with an elastic membrane attached having one or more rigid plates are attached. The rigid plates have asymmetric shapes, with a substantially straight edge at the attachment to said elastic membrane, so that the rigid plate establishes a cell having a predetermined mass. Vibrational motions of the structure contain a number of resonant modes with tunable resonant frequencies

U.S. Pat. No. 8,960,365 B2 describes an acoustic/vibrational energy absorption metamaterial which includes at least one enclosed planar frame with an elastic membrane attached having one or more rigid plates are attached. The rigid plates have asymmetric shapes, with a substantially straight edge at the attachment to said elastic membrane, so that the rigid plate establishes a cell having a predetermined mass. Vibrational motions of the structure contain a number of resonant modes with tunable resonant frequencies.

U.S. Pat. No. 4,425,981 describes a sound-absorbing building component for indoor paneling consisting of at least two superimposed sheets, preferably made of a synthetic resin. At least one of the sheets is provided with cup-shaped indentations lying side-by-side in the manner of a grid, the bottom surfaces of these indentations being excitable to lossy vibrations upon the incidence of sound. The upper rims of the cup-shaped indentations are all covered by a further planar sheet which is likewise capable of vibrations. This further sheet seals off the air volumes contained in the individual cup-shaped indentations in an airtight fashion. Small lumpy or irregularly-sized bodies can be provided on the bottom surfaces of the cup-shaped indentations.

EP 1 022 721 A2 describes a sound-absorbing structure comprising a thin flexible film supported on a support in the form of an array of walls forming a grid of cells closed off by the film. The film may be secured continuously to the upper surface of all the walls or may be only intermittently secured to the walls, but in each case to define a plurality of elemental parts of the surface of the film which are independently vibratable at respective resonant frequencies in response to incident sound waves to cause loss of energy thereof. The support is made of thin flexible material, such as foamed thermoplastic or rubber material, and preferably it is made from recycled low density, low cost materials. Because sound absorption occurs by a surface-resonance phenomenon, the structure can be only a few millimeters thick. The underside of the structure can be mounted on a sheet-like support member, advantageously flexible, this member in turn being mounted on the wall of a space in which occurs the sound to be absorbed, such as, for example, the engine compartment of a motor vehicle. Instead, the underside of the support can be directly mounted on a wall of the engine compartment.

U.S. Pat. No. 7,249,653 B2 describes acoustic attenuation materials that comprise outer layers of a stiff material sandwiching a relatively soft elastic material therebetween, with means such as spheres, discs or wire mesh being provided within the elastic material for generating local mechanical resonances that function to absorb sound energy at tunable wavelengths.

U.S. Pat. No. 5,545,861 A describes a membranous-vibration sound absorbing material which can achieve not only good sound absorbing characteristics, workability and strength but also trans-parency. The membranous-vibration sound absorbing material can also achieve dust-proof and dust-free properties when necessary and can be suitably used for application in clean rooms and the like.

US 2014/027201 A1 describes metamaterial members for absorbing sound and pressure, and modular systems built of metamaterial members. The metamaterial member includes an outer mass. The outer mass can have a cavity formed therein in which a stem coupled to an inner mass is disposed, or the outer mass can be solid and contain an inner mass embedded therein. The inner mass can include an inner core and an outer shell. Multiple metamaterial members can be attached to form a modular system for absorption of sound and pressure.

US 2014/116802 A1 describes a device with simultaneous negative effective mass density and bulk modulus that has at least one tubular section and front and back membranes sealing the tubular section. The front and back membranes sealing the tubular sections seal the tubular section sufficiently to establish a sealed or restricted enclosed fluid space defined by the tubular section and the membranes, and restrict escape or intake of fluid resulting from acoustic vibrations. A pair of platelets are mounted to the membranes, with the individual platelets substantially centered on respective ones of the front and back membranes.

KR 2019 0090146 A describes an apparatus for reducing a floor impact sound of a low frequency band using an acoustic meta material and a method thereof. The apparatus for reducing a floor impact sound reduces a floor impact sound of a low frequency band in a floating floor structure where a floor plate forming a floor of an upper floor of a building, a lower plate dividing the upper floor and a lower floor, and a buffer layer arranged between the floor plate and the lower plate are stacked on top of each other. The apparatus for reducing a floor impact sound includes a plurality of acoustic meta materials. Acoustic meta material composites are arranged in group units along a flat area of the floating floor structure to reduce a floor impact sound of a low frequency band in response to a bending wave vibration pattern in a merging mode where the floor plate and the lower plate are simultaneously bent and vibrated by a floor impact and a non-merging mode where the lower plate is bent and vibrated. A frequency band having the largest effect on a floor impact sound is selected by merging and non-merging mode occurrence characteristics of a floating floor structure to optimize and apply acoustic meta materials to the floating floor structure to reduce corresponding modes to effectively reduce a floor impact sound of a low frequency band.

Despite the achievements in sound insulation implied by the above-mentioned materials and devices a demand exists in a low-frequency, light-weight sound isolation. Specifically in construction industry, an improved sound insulation is needed of sound from ambient noises such from traffic and voices. Sound from these ambient noises is within a low frequency range such as in a frequency range from 60 Hz to 500 Hz. Above frequencies of 500 Hz the mass law of sound insulation allows easy realization of sound insulation devices. However, existing acoustic panels fail in the frequencies below 300-500 Hz, even with bulky frames. Moreover, it is desirable to gain living space by using thin walls and to allow easy and failsafe installation.

### PROBLEM ADDRESSED BY THE INVENTION

It is therefore an object of the present invention to provide devices and methods facing the above-mentioned technical challenges of known devices and methods. Specifically, it is an object of the present invention to provide devices and methods which allow for low-frequency, light-weight sound isolation.

### SUMMARY OF THE INVENTION

This problem is solved by the invention with the features of the independent patent claims. Advantageous developments of the invention, which can be realized individually or in combination, are presented in the dependent claims and/or in the following specification and detailed embodiments.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such a way with other optional or non-optional features of the invention.

In a first aspect of the present invention a sound insulation device is disclosed. As used herein, the term “sound insulation device” is a broad term and is to be given its ordinary and customary meaning to a person of ordinary skill in the art and is not to be limited to a special or customized meaning. The term specifically may refer, without limitation, to an arbitrarily shaped structure configured to block and/or to reduce acoustic energy transmission through the structure. The sound insulation device may be a light-weight sound insulation device. For example, the sound insulation device may have a weight of 0.60 kg/m² or less. The sound insulation device may cover an area of greater or equal than 0.5 m×0.5 m. Preferably the sound insulation device may cover an area of more than or equal to 1 m×1 m. For example, the sound insulation device may have a size of 1.07 m×1.07 m×0.02 m.

The sound insulation device comprises at least one rigid support element and at least one elastic membrane element. The rigid support element comprises at least one support grid. The support grid comprises a plurality of cells. The elastic membrane element is arranged on the support grid. The sound insulation device is configured to block at least partially acoustic energy transmission at a frequency range of 60 Hz to 500 Hz. The sound insulation device exhibits a negative effective mass below a resonance frequency, wherein the resonance frequency is given by

$${ω}_{0} = \frac{4 π δ}{A} \sqrt{\frac{E}{ρ ( 1 - {ϑ}^{2} )}} ,$$

wherein A is a pore size of the support grid spun by the membrane element, δ is a thickness of the membrane element, E an elastic modulus of the membrane element, ρ is a density of the membrane element and ϑ is a Poisson ratio of the membrane element. The elastic modulus E of the membrane element is ≥8 MPa.

The sound insulation device is configured to block at least partially acoustic energy transmission at a frequency range of 60 Hz to 500 Hz. As used herein, the term “to block” is a broad term and is to be given its ordinary and customary meaning to a person of ordinary skill in the art and is not to be limited to a special or customized meaning. The term specifically may refer, without limitation, to preventing acoustic energy transmission through the sound insulation device. As used herein, the term “at least partially block” refers to complete and/or at least partial sound transmission loss. The sound insulation device may be configured to block more or equal than 50%, preferably more or equal than 70%, most preferably more or equal than 90%, of acoustic energy transmission at the frequency range of 60 Hz to 500 Hz. Decrease of sound intensity across a barrier may be defined by sound transmission loss

Sound Transmission Loss=10log₁₀(W_{incident}/W_{transmitted})

wherein W_{incident} is the incident power at one side of the sound insulation device and W_{transmitted} is the transmitted power at an opposing side of the sound insulation device.

As used herein, the term “support element” is a broad term and is to be given its ordinary and customary meaning to a person of ordinary skill in the art and is not to be limited to a special or customized meaning. The term specifically may refer, without limitation, to an arbitrary shaped element configured such that at least one further element of the sound insulation device can be arranged on the support element and/or configured to carry and/or hold and/or sustain at least one further element of the sound insulation device. The support element may be configured as a holding structure. The support element may be monolithic. The support element may have a circular and/or plate-like shape.

The term “rigid” is a broad term and is to be given its ordinary and customary meaning to a person of ordinary skill in the art and is not to be limited to a special or customized meaning. The term specifically may refer, without limitation, to a suitability of the support element to resist mechanical influences and physical stress such as bending. Specifically, the term “rigid” may refer to stiffness of the support element. The support element may have such rigidity that vibration of the sound insulation device as a whole is prevented. The support element may have a maximum flexibility given by R=a⁴/D with “a” being the, circularly defined, area of the support element and D its bending stiffness, wherein R may be ≤10 m³/N, preferably ≤1 m³/N. For example, meaning of the R value can be understood as follows. In case of a square support element, the support element may be fixed at the corners and central of the support element a force may be exerted alone a surface normal which results in bending of the support element. In this example, the bending of the support element is described by “D” and “a” is given by a distance between edges of the support element at which the support element is fixed.

The support element may be a very stiff ground support. For example, the support element may have a compressibility of 50 to 500 μm at a pressure of 2N/m², preferably of 100 to 300 μm, more preferably of 150 to 250 μm. As used herein, the term “compressibility” refers to a measure of a relative volume change of the support element, specifically a completely fixed support element, as a response to a force.

The support element comprises the at least one support grid. The support grid comprises the plurality of cells. As used herein, the term “support grid”, also denoted support structure, is a broad term and is to be given its ordinary and customary meaning to a person of ordinary skill in the art and is not to be limited to a special or customized meaning. The term specifically may refer, without limitation, to an arrangement of a plurality of cells in a predetermined geometrical order. The support grid may be or may comprise a mesh. Specifically, the support grid may be a porous substrate such as a honeycomb. As further used herein, the term “cell” refers to an opening of the support grid. A geometry of the cells of the support grid may be selected from the group consisting of triangle, square, circular and hexagon. Geometry of the support structure may affect the resonance behavior of the membrane element. The support grid specifically may be or may comprise a rectangular matrix having one or more rows and one or more columns. The rows and columns specifically may be arranged in a rectangular fashion. It shall be outlined, however, that other arrangements are feasible, such as nonrectangular arrangements. As an example, hexagonal arrangements are also feasible, wherein the base element may be a honeycomb base panel. Preferred geometry for the cells may be a square cell geometry, specifically in terms of increase in blockage of noise energy. At the same time, solidity of the support structure may be of importance. In order to avoid side wise movement of the support structure or to have higher mechanical strength, a hexagonal cell geometry may be preferred. Other arrangements are feasible. Moreover, usage of a support grid comprising a plurality of openings allows for reducing weight of the overall structure.

The support grid may have various patterns of graded cells sizes. As used herein, the term “cell size” is a broad term and is to be given its ordinary and customary meaning to a person of ordinary skill in the art and is not to be limited to a special or customized meaning. The term specifically may refer, without limitation, to a diagonal distance of openings in the support grid. The support grid may have a uniform structure with identical cell size. Alternatively, the support grid may have a non-uniform structure. For example, the cells may have a cell size from 2 to 10 mm, preferable from 3 to 5 mm. For example, the support grid may be a honeycomb structure with cell diagonal length of 3 mm. For example, the support grid may be a honeycomb structure with cell diagonal length of 4.75 mm. It was found that decreasing the size of the openings of the support grid increases the average sound transmission loss. The limiting factor, however, may be the weight of the overall structure.

The support element may comprise at least one first surface, such as an upper surface, on which the elastic membrane element may be placed. The support element may comprise at least one second surface, opposing the first surface, which may be configured as outer surface of the sound insulation device.

The rigid support element further may comprise at last one base element and/or at least one additional support grid, in particular in order to provide sufficient rigidity and/or stiffness to the support element. The support grid may provide sufficient rigidity and/or stiffness alone such that no additional base elements and/or support grids are necessary. For example, the rigid support element may comprise two support grids, e.g. laminated to each other. As used herein, the term “base element” is a broad term and is to be given its ordinary and customary meaning to a person of ordinary skill in the art and is not to be limited to a special or customized meaning. The term specifically may refer, without limitation, to an element of the rigid support element designed as ground element and/or base panel of the sound insulation device configured to provide sufficient rigidity and/or stiffness or additional sufficient rigidity and/or stiffness to the support element. The base element may be configured to support the support grid.

The support element may be configured to protect the elastic membrane element from physical stress. Specifically, the support element may have mechanical properties such it limits the maximum curvature of the membrane to 20 times the membrane thickness, preferably 15 times. The mechanical strength of the support element, in particular of the grid itself or with a backing wall, may be defined by flexural rigidity D:

$$D = \frac{E {H}^{3}}{12 ( 1 - {ϑ}^{2 )}} [ P a {m}^{3} ] .$$

The parameters in this equation refer to the support grid; either a single honeycomb or a layered supporting wall. H is the thickness of the support structure, E is the elastic modulus and v is the Poisson's ratio. Flexural rigidity may refer to the force couple required to bend a fixed non-rigid structure in one unit of curvature and/or can be defined as the resistance offered by a structure while undergoing bending. The flexural rigidity of the support element may be 0.48 Pa m³ or higher, preferably 0.8 Pa m³ or higher. For example, the compressive strength may be between 5.8 MPa to 15 MPa. With a thickness of 1 cm, the range of acceptable flexural rigidity for the panel may be between 0.48 to 0.8 Pa m³. Of course higher values may improve the performance.

The maximum bending curvature may indicate maximum of the bending curvature allowed by the base element. The support element may have a compressive strength in a range from 1.00 MPa to 7.00 MPa. The support element may have a density in a range from 20 kg/m³ to 100 kg/m³. The support element may have a plate shear longitudinal direction strength in a range from 1.3 MPa to 3.86 MPa, preferably 2 to 3.8, more preferably 2.5 to 3.5 and modulus in a range from 0.070 GPa to 0.162 GPa, preferably 0.08 to 0.16, more preferably 0.1 to 0.15. The support element may have a plate shear transverse direction strength in a range from 0.62 MPa to 2.17 MPa, preferably 0.65 to 2.1, more preferably 0.7 to 2. and modulus in a range from 0.042 GPa to 0.100 GPa, preferably 0.045 to 0.1, more preferably 0.05 to 0.095. The support element may have a thickness of around 10 mm. Mechanical strength of the support element may be of importance to the function of the sound insulation device. The support element may be completely fixed and immobile. Specifically, the membrane element may be arranged on the support grid such that the membrane element is as inflexibly as possible.

The support element, and in particular the support grid, may comprise one or more of: metal, ceramic, polyamide, fiber-reinforced polymer, glass, polyacrylate and aramid. For example, the support grid may comprise a metal grid and/or a grid of glass fibers and/or a grid of aramid fibers, wherein light weight materials are preferred. For example, the support element may comprise an aluminum honeycomb. Specifically, as outlined above, the sound insulation device may have a weight of 0.60 kg/m² or less.

As used herein, the term “elastic membrane element” is a broad term and is to be given its ordinary and customary meaning to a person of ordinary skill in the art and is not to be limited to a special or customized meaning. The term specifically may refer, without limitation, to a thin elastic layer configured to vibrate. For example, the elastic membrane element may comprise at least one thermoplastic Polyurethane (TPU) membrane and/or at least one rubber membrane such as comprising one or more of polyisoprene, polyisobutylene, natural rubber, plasticized polyvinylchloride. Other membrane elements are, however, possible.

The sound insulation device may be a metamaterial device. As used herein, the term “metamaterial” is a broad term and is to be given its ordinary and customary meaning to a person of ordinary skill in the art and is not to be limited to a special or customized meaning. The term specifically may refer, without limitation, to properties of material and structure of the sound insulation device to exhibit a negative effective mass. Specifically, vibration behavior of the membrane element may result in the negative effective mass, denoted as metamaterial effect. When excited by an external force, most materials react in phase with the excitation. Metamaterial systems may be designed to react out of phase with the external excitation, see Shanshan Yao, Xiaoming Zhou and Gengkai Hu, “Experimental study on negative effective mass in a 1D mass-spring system”, New Journal of Physics 10 (2008) 043020 (11pp). In the study of wave propagation within such fluid-solid composites, it was found that the dynamic density is not the same as the static density. Due to the vibration of internal masses in such material systems, Newton's laws stand if the mass is replaced by effective mass. Effective mass is a function of frequency of the harmonic force applied to the system and can have negative values, see Graeme W. Milton, John R. Willis, “On modifications of Newton's second law and linear continuum elastodynamics”, Proc. R. Soc. A (2007) 463, 855-880.

The sound insulation device exhibits a negative effective mass below a resonance frequency ω₀. The resonance frequency ω₀ is a function of membrane properties and can furthermore describes by

$${ω}_{0} = \frac{4 π δ}{A} \sqrt{\frac{E}{ρ ( 1 - {ϑ}^{2} )}} ,$$

wherein A is a pore size of the support grid spun by the membrane element, δ is a thickness of the membrane element, E an elastic modulus of the membrane element, ρ is a density of the membrane element and ϑ is a Poisson ratio of the membrane element. The sound insulation device may comprise elements, i.e. the membrane element and the support grid, having materials fulfilling this equation. The effective mass can be described as

$${M}_{eff} = m ( 1 - \frac{{ω}_{0}^{2}}{{ω}^{2}} ) .$$

For frequencies below ω₀, the effective mass of the system is negative leading to high sound transmission loss at low frequencies. The resonance frequency ω₀ may be ≤5000 Hz, preferably ≤3000. The resonance frequency may be from 1000 Hz to 5000 Hz, preferably 1000 Hz to 3000 Hz.

Preferably, the elastic modulus E of the membrane element is ≥8 MPa, preferably between 8 MPa and 25 MPa, preferably between 8.5 and 20 MPa for elongations up to 10%. By increasing the elastic modulus the resonance frequency may be shifted towards higher frequencies. The elastic modulus can be determined by tensile testing, in particular according to DIN EN ISO 527-1A. The elastic modulus can be determined from an initial slope of a stress-strain curve as ratio of stress to strain.

Preferably, the density of the membrane element may be in a range of 900 kg/m³≤ρ≤1200 kg/m³. As the density increases the resonance frequency may be shifted towards higher frequencies, however, in expense of increased weight of the sound insulation device. Therefore, the membrane density may be towards a lower limit of an available material with the required elastic modulus. The membrane element may be a porous membrane element. This may allow decoupling the thickness of the membrane element and the thickness of the membrane element.

Preferably, the thickness of the membrane element may be in a range of in a range of 0.05≤δ≤1 mm, preferably 0.1≤δ≤0.5 mm, most preferably 0.20≤δ≤0.30 mm. However, the thickness increases the vibrating mass increases, too. The thickness may be selected such the vibrating mass is on the one hand not too big and on the other hand that the membrane element is thick enough to avoid rupturing. Therefore, intermediate thickness of the membrane element is preferred.

The support grid may comprise a plurality of pores spun by the membrane element each having a pore size. As used herein, the term “pore size A” of the support grid spun by the membrane element refers to effective radius of pores of the support grid spun by the membrane element. The pore size A of the support grid spun by the membrane element may be from 1 to 500 mm², preferably from 5 to 300 mm², most preferably from 10 to 100 mm². A proportion of the pores to the total area of the membrane element may be from 50% to 95%, preferably from 60% to 90%, most preferably from 65% to 85%.

Preferably, the Poisson ratio ϑ of the membrane element may be in a range of 0.47≤ϑ≤0.50.

Metamaterials may be susceptible above certain stiffness. Preferably, the membrane element may have an ultimate elongation from 10 to 400%, preferably from 50 to 350%, more preferably from 100 to 300%.

The support element furthermore may comprise at least one cover element. As used herein, the term “cover element” is a broad term and is to be given its ordinary and customary meaning to a person of ordinary skill in the art and is not to be limited to a special or customized meaning. The term specifically may refer, without limitation, to an element of the support element configured to cover the membrane element, specifically in order to protect the elastic membrane element from physical stress. The cover element and the base element may have identical mechanical and physical properties such as mechanical strength. The cover element may comprise a further support grid comprising a plurality of cells. The geometry and arrangement of the cells of the further support grid may be identical or different to the geometry and arrangement of the support grid of the base element. The membrane element may be sandwiched between the base element and the cover element.

The membrane element may be attached to the support element, specifically to the support grid and/or the cover element by at least one fastening connection. The membrane element may be attached to the support element such that each of the edges of the membrane element is fixed on the support element. The fastening connection may be at least one connection selected from the group consisting of: a form-fit connection, a frictional connection, and a bonded connection. For example, the membrane element may be attached to the support element by at least one adhesive. The adhesive may be or may comprise an arbitrary type of adhesive, such as one or more cross-linkable monomers, oligomers or polymers. Preferably, the adhesive may be or may comprise a polyurethane based adhesive. The adhesive may be a liquid adhesive which may be hardened by one or more of drying, exerting pressure, exerting heat, exerting radiation. Additionally or alternatively, the membrane element may be attached to the support element by one or more of: at least one clamping connection, at least one screwing connection, at least one rivet connection or the like. Other fastening connections are however possible.

The sound insulation device may comprise at least one stack. The stack may comprise at least two layers arranged in a stacked fashion each layer comprising a support grid and a membrane element attached to the support grid. The stack may comprise a plurality of layers arranged in a stacked fashion each layer comprising a support grid and a membrane element attached to the support grid.

In a further aspect, the present invention discloses a manufacturing method for manufacturing at least one sound insulation device configured for blocking at least partially acoustic energy transmission at a frequency range of 60 Hz to 500 Hz according to the present invention, such as according to one or more of the embodiments referring to a detector as disclosed above or as disclosed in further detail below. The method comprises the following method steps, wherein the method steps may be performed in the given order or may be performed in a different order. Further, one or more additional method steps may be present which are not listed. Further, one, more than one or even all of the method steps may be performed repeatedly.

The method comprises the following steps:
a) providing at least one rigid support element, wherein the rigid support element comprises at last one support grid, wherein the support grid comprises a plurality of cells;
b) providing at least one elastic membrane element, wherein the support grid has a pore size A spun by the membrane element, wherein the membrane element has a thickness δ, a density ρ, an elastic modulus E≥8 MPa and Poisson ration ϑ such that in an assembled state the sound insulation device exhibits a negative effective mass below a resonance frequency

$${ω}_{0} = \frac{4 π δ}{A} \sqrt{\frac{E}{ρ ( 1 - {ϑ}^{2} )}} ;$$

c) attaching the membrane element to the support element.

The method further may comprise
d) providing at least one cover element comprising a further support grid, wherein the further support grid comprises a plurality of cells;
e) attaching the membrane element to the cover element such that the membrane element is sandwiched between the support grid and the further support grid.

For details, options and definitions, reference may be made to the sound insulation device as discussed above.

The membrane element may be fixed on the support grid using at least one chemical adhesive. The adhesive may be a water activated Polyurethane base formula, for example an adhesive available by the commercial name of “original Gorilla glue®”. The adhesive may be applied evenly on the base element, for example using a foam brush. Additionally or alternatively, the membrane element may be fixed on the base element and/or the cover element by one or more of at least one clamping connection, at least one screwing connection, at least one rivet connection or the like. Other fastening connections are however possible. The membrane element may be placed on the base element and stretched to ensure that no wrinkle is formed.

For example, the support grid and the cover element may have dimensions of 107×107 mm, with thickness of 6 mm, and may have hexagonal cavities with diameter of 4 mm. The base element and the cover element may be made of aramid fiber available under PLASCORE® Kevlar®—PK2-1/8-6.0 HS with a density of 96.1 kg/m³, compressive strength of 6.89 MPa, plate shear longitudinal direction strength of 3.86 MPa and modulus of 0.162 GPa, and plate shear transverse direction strength of 2.17 MPa and modulus of 0.100 GPa (AMS3711). The membrane material may be thermoplastic Polyurethane (TPU) with thickness of 25 μm, elastic modulus of 11 MPa, and density of 1.2 g/cm³.

A steel plate, e.g. a 5 mm thick steel plate, the same area at the support grid, may be placed on top of the glued membrane element and a weight, e.g. of 40 Kg, may be placed on top of the steel plate. The pressure may be to hold the membrane element in place during the adhesive curing time and avoid formation of wrinkles. After curing, such as after 24h curing time at 24° C., the cover element may be glued and placed on the other side of the membrane element analogously. The three layer sandwich composite may be placed in a metal frame. The frame may have a C shape section, with exact size as the thickness of the sandwich composite. The frame may be just for mounting reasons and does not contribute to the overall stiffness of the frame. The sandwich composite may be placed in the frame and the sides of the frame are screwed together at corners.

In a further aspect of the present invention, use of the sound insulation device according to the present invention is proposed for a purpose of use selected from the group consisting of: a wall sound transmission loss panel; a noise protection installations next to roads, tracks, or fabrication units, a sound blocking elements in electrical generator casings, and casings of rotating elements such as compressors of air conditioning casings.

Overall, in the context of the present invention, the following embodiments are regarded as preferred:

Embodiment 1: A sound insulation device comprising at least one rigid support element and at least one elastic membrane element, wherein the rigid support element comprises at last one support grid, wherein the support grid comprises a plurality of cells, wherein the elastic membrane element is arranged on the support grid, wherein the sound insulation device is configured to block at least partially acoustic energy transmission at a frequency range of 60 Hz to 500 Hz, wherein the sound insulation device exhibits a negative effective mass below a resonance frequency, wherein the resonance frequency is given by

$${ω}_{0} = \frac{4 π δ}{A} \sqrt{\frac{E}{ρ ( 1 - {ϑ}^{2} )}} ,$$

wherein A is a pore size of the support grid spun by the membrane element, δ is a thickness of the membrane element, E an elastic modulus of the membrane element, ρ is a density of the membrane element and ϑ is a Poisson ratio of the membrane element, wherein the elastic modulus E of the membrane element is ≥8 MPa.

Embodiment 2: The sound insulation device according to the preceding embodiment, wherein the sound insulation device is a metamaterial device.

Embodiment 3: The sound insulation device according to any one of the preceding embodiments, wherein the elastic membrane element comprises at least one thermoplastic Polyurethane (TPU) membrane.

Embodiment 4: The sound insulation device according to any one of the preceding embodiments, wherein the sound insulation device is configured to block more or equal than 50%, preferably more or equal than 70%, most preferably more or equal than 90%, of acoustic energy transmission at the frequency range of 60 Hz to 500 Hz.

Embodiment 5: The sound insulation device according to any one of the preceding embodiments, wherein the resonance frequency ω₀ is ≤5000 Hz, preferably ≤3000.

Embodiment 6: The sound insulation device according to any one of the preceding embodiments, wherein the pore size A of the support grid spun by the membrane element is from 1 to 500 mm², preferably from 5 to 300 mm², most preferably from 10 to 100 mm², wherein a proportion of the pores to the total area of the membrane element is from 50% to 95%, preferably from 60% to 90%, most preferably from 65% to 85%.

Embodiment 7: The sound insulation device according to any one of the preceding embodiments, wherein the thickness of the membrane element is in a range of 0.05≤δ≤1 mm, preferably 0.1≤δ≤0.5 mm, most preferably in a range of 0.20≤δ≤0.30 mm.

Embodiment 8: The sound insulation device according to any one of the preceding embodiments, wherein the density of the membrane element is in a range of 900 kg/m³≤ρ≤1200 kg/m³.

Embodiment 9: The sound insulation device according to any one of the preceding embodiments, wherein Poisson ratio ϑ of the membrane element is in a range of 0.47≤ϑ≤0.50.

Embodiment 10: The sound insulation device according to any one of the preceding embodiments, wherein the membrane element has an ultimate elongation from 10 to 400%, preferably from 50 to 350%, more preferably from 100 to 300%.

Embodiment 11: The sound insulation device according to any one of the preceding embodiments, wherein a geometry of the cells of the support grid is selected from the group consisting of triangle, square, circular and hexagon.

Embodiment 12: The sound insulation device according to any one of the preceding embodiments, wherein the support grid is a honeycomb support grid.

Embodiment 13: The sound insulation device according to any one of the preceding embodiments, wherein the support element, specifically the support grid comprises one or more of: metal, ceramic, polyamide, fiber-reinforced polymer, glass, polyacrylate and aramid.

Embodiment 14: The sound insulation device according to any one of the preceding embodiments, wherein the support element has a compressive strength in a range from 1.00 MPa to 7.00 MPa.

Embodiment 15: The sound insulation device according to any one of the preceding embodiments, wherein the support element has a plate shear longitudinal direction strength in a range from 1.3 MPa to 3.86 MPa, preferably 2 to 3.8, more preferably 2.5 to 3.5 and modulus in a range from 0.070 GPa to 0.162 GPa, preferably 0.08 to 0.16, more preferably 0.1 to 0.15.

Embodiment 16: The sound insulation device according to any one of the preceding embodiments, wherein the support element has a plate shear transverse direction strength in a range from 0.62 MPa to 2.17 MPa, preferably 0.65 to 2.1, more preferably 0.7 to 2 and modulus in a range from 0.042 GPa to 0.100 GPa, preferably 0.045 to 0.1, more preferably 0.05 to 0.095.

Embodiment 17: The sound insulation device according to any one of the preceding embodiments, wherein the sound insulation device has a weight of 0.60 kg/m² or less.

Embodiment 18: The sound insulation device according to any one of the preceding embodiments, wherein the sound insulation device covers an area of greater or equal than 0.5 m×0.5 m, preferably of greater or equal than 1 m×1 m.

Embodiment 19: The sound insulation device according to any one of the preceding embodiments, wherein the support element further comprises at least one cover element comprising a further support grid having a plurality of cells, wherein the elastic membrane element is sandwiched between the support grid and the cover element.

Embodiment 20: The sound insulation device according to the preceding embodiment, wherein the membrane element is attached to the support grid and/or the cover element by at least one polyurethane based adhesive.

Embodiment 21: Manufacturing method for manufacturing at least one sound insulation device configured for blocking at least partially acoustic energy transmission at a frequency range of 60 Hz to 500 Hz according to any one of the preceding embodiments, wherein the method comprises the following steps:
a) Providing at least one rigid support element, wherein the rigid support element comprises at last one support grid, wherein the support grid comprises a plurality of cells;
b) Providing at least one elastic membrane element, wherein the support grid has a pore size A spun by the membrane element, wherein the membrane element has a thickness δ, a density ρ, an elastic modulus E≥8 MPa and Poisson ration ϑ such that in an assembled state the sound insulation device exhibits a negative effective mass below a resonance frequency

$${ω}_{0} = \frac{4 π δ}{A} \sqrt{\frac{E}{ρ ( 1 - {ϑ}^{2} )}} ;$$

c) Attaching the membrane element to the support element.

Embodiment 22: The method according to the preceding embodiment, wherein the method further comprises
d) Providing at least one cover element comprising a further support grid, wherein the further support grid comprises a plurality of cells;
e) Attaching the membrane element to the cover element such that the membrane element is sandwiched between the support grid and the further support grid.

Embodiment 23: A use of the sound insulation device according to any one of the preceding embodiments referring to a sound insulation device for a purpose of use selected from the group consisting of: a wall sound transmission loss panel; a noise protection installations next to roads, tracks, or fabrication units, a sound blocking elements in electrical generator casings, and casings of rotating elements such as compressors of air conditioning casings.

### BRIEF DESCRIPTION OF THE FIGURES

Further optional details and features of the invention are evident from the description of preferred exemplary embodiments which follows in conjunction with the dependent claims. In this context, the particular features may be implemented in an isolated fashion or in combination with other features. The invention is not restricted to the exemplary embodiments. The exemplary embodiments are shown schematically in the figures. Identical reference numerals in the individual figures refer to identical elements or elements with identical function, or elements which correspond to one another with regard to their functions.

Specifically, in the figures:

FIG. 1 shows an exemplary embodiment of a sound insulation device according to the present invention;

FIG. 2 shows experimental results of a sound transmission loss curve in comparison to numerical simulation;

FIG. 3 shows numerical simulation results showing effect of membrane elastic modulus on sound transmission loss;

FIG. 4 shows numerical simulation results showing effect of membrane density on sound transmission loss;

FIG. 5 shows experimental results on effect of cell size of a support element on sound transmission loss; and

FIGS. 6A to D show comparison of cell geometries.

### DETAILED DESCRIPTION OF THE EMBODIMENTS

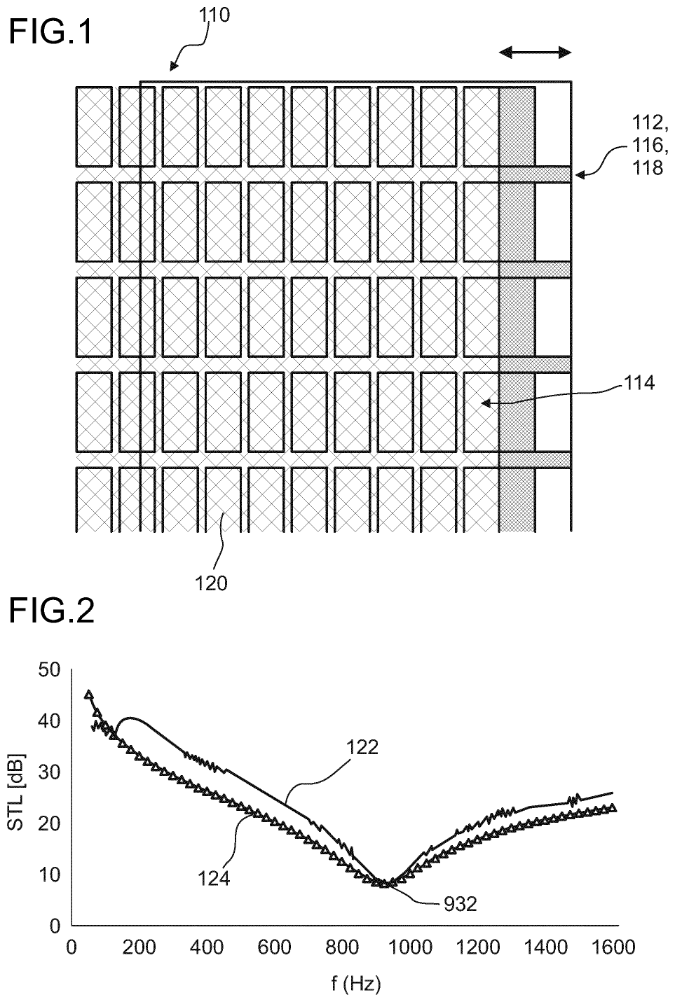

In FIG. 1, schematically an exemplary embodiment of a sound insulation device 110 according to the present invention is shown. The sound insulation device 110 may be a light-weight sound insulation device. The sound insulation device 110 may have a weight of 0.60 kg/m² or less. The sound insulation device 110 may cover an area of greater or equal than 0.5 m×0.5 m. Preferably the sound insulation device 110 may cover an area of more than or equal to 1 m×1 m. The sound insulation device 110 may have a size of 1.07 m×1.07 m×0.02 m.

The sound insulation device 110 comprises at least one rigid support element 112 and at least one elastic membrane element 114. For example, the elastic membrane element 114 may comprise at least one thermoplastic Polyurethane (TPU) membrane and/or at least one rubber membrane. Other membrane elements 114 are, however, possible. The support element 112 may be configured as a holding structure. The support element 112 may be monolithic. The support element 112 may have a circular and/or plate-like shape. The support element 112 may be a very stiff ground support. For example, the support element 112 may have a compressibility of 2 N/m² of maximum 500 μm. The support element 112 may have a maximum flexibility given by R=a⁴/D with “a” being the, circularly defined, area of the support element and D its bending stiffness, wherein R may be ≤10, preferably ≤1.

The rigid support element 112 comprises at least one support grid 118. The support element 112 may additionally comprise at last one base element 116 and/or at least one additional support grid, in particular in order to provide sufficient rigidity and/or stiffness to the support element 112. The support grid 118 may provide sufficient rigidity and/or stiffness alone such that no additional base element 116 and/or support grid are necessary. For example, the rigid support element 112 may comprise two support grids, e.g. laminated to each other. The support grid 118 may comprise at least one first surface, such as an upper surface, on which the elastic membrane element 114 may be placed. The support grid 118 may comprise at least one second surface, opposing the first surface, which may be configured as outer surface of the sound insulation device 110. The support element 112 may be configured to protect the elastic membrane element 114 from physical stress. Specifically, the support element 112 may have mechanical properties such that it limits the maximum curvature of the membrane to 20 times the membrane thickness, preferably 15 times. The maximum bending curvature may indicate maximum of the bending curvature allowed by the base element 116. The support element 112 may have a compressive strength in a range from 1.00 MPa to 7.00 MPa. The support element 112 may have a density in a range from 20 kg/m³ to 100 kg/m³. The support element 112 may have a plate shear longitudinal direction strength in a range from 1.3 MPa to 3.86 MPa, preferably 2 to 3.8, more preferably 2.5 to 3.5 and modulus in a range from 0.070 GPa to 0.162 GPa, preferably 0.08 to 0.16, more preferably 0.1 to 0.15. The support element 112 may have a plate shear transverse direction strength in a range from 0.62 MPa to 2.17 MPa, preferably 0.65 to 2.1, more preferably 0.7 to 2, and modulus in a range from 0.042 GPa to 0.100 GPa, preferably 0.045 to 0.1, more preferably 0.05 to 0.095. The support element 112 may have a thickness of 10 mm. Mechanical strength of the support element 112 may be of importance to the function of the sound insulation device. The support element 112 may be completely fixed and immobile. The elastic membrane element 114 is arranged on the support grid 118. The membrane element 114 may be arranged on the support grid 118 such that the membrane element 114 is as inflexibly as possible.

The support grid 118 comprises a plurality of cells 120. The support grid 118 may be or may comprise a mesh. Specifically, the support grid 118 may be a porous substrate such as a honeycomb. A geometry of the cells 120 of the support grid 118 may be selected from the group consisting of triangle, square, circular and hexagon. Geometry of the support structure may affect the resonance behavior of the membrane element 114. The support grid 118 specifically may be or may comprise a rectangular matrix having one or more rows and one or more columns. The rows and columns specifically may be arranged in a rectangular fashion. It shall be outlined, however, that other arrangements are feasible, such as nonrectangular arrangements. As an example, hexagonal arrangements are also feasible, wherein the base element may be a honeycomb base panel. Preferred geometry for the cells 120 may be a square cell geometry, specifically in terms of increase in blockage of noise energy. At the same time, solidity of the support structure may be of importance. In order to avoid side wise movement of the support structure or to have higher mechanical strength, a hexagonal cell geometry may be preferred. Other arrangements are feasible. Moreover, usage of a support grid comprising a plurality of openings allows for reducing weight of the overall structure.

The support grid 118 may have various patterns of graded cells sizes. The support grid 118 may have a uniform structure with identical cell size. Alternatively, the support grid 118 may have a non-uniform structure. For example, the cells 120 may have a cell size from 2 to 10 mm, preferable from 3 to 5 mm. For example, the support grid 118 may be a honeycomb structure with cell diagonal length of 3 mm. For example, the support grid 118 may be a honeycomb structure with cell diagonal length of 4.75 mm.

The support element 112, and in particular the support grid 118, may comprise one or more of: metal, ceramic, polyamide, fiber-reinforced polymer, glass, polyacrylate and aramid. For example, the support grid may comprise a metal grid and/or a grid of glass fibers and/or a grid of aramid fibers, wherein light weight materials are preferred. For example, the support element 112 may comprise an aluminum honeycomb. Specifically, as outlined above, the sound insulation device 110 may have a weight of 0.60 kg/m² or less.

The support element 112 furthermore may comprise at least one cover element, not shown here. The cover element and the support grid 118 may have identical mechanical and physical properties such as mechanical strength. The cover element may comprise a further support grid comprising a plurality of cells. The geometry and arrangement of the cells of the further support grid may be identical or different to the geometry and arrangement of the support grid of the base element 116. The membrane element 114 may be sandwiched between the support grid 118 and the cover element. The membrane element 114 may be attached to the support grid 118 and/or the cover element by at least one polyurethane based adhesive.

The sound insulation device 110 is configured to block at least partially acoustic energy transmission at a frequency range of 60 Hz to 500 Hz. The sound insulation device 110 may be configured to block more or equal than 50%, preferably more or equal than 70%, most preferably more or equal than 90%, of acoustic energy transmission at the frequency range of 60 Hz to 500 Hz. Decrease of sound intensity across a barrier may be defined by transmission loss Transmission Loss=10log₁₀ (W_{incident}/W_{transmitted}), wherein W_{incident} is the incident power at one side of the sound insulation device and W_{transmitted} is the transmitted power at an opposing side of the sound insulation device.

The sound insulation device 110 may be a metamaterial device. The sound insulation device 110 exhibits a negative effective mass below a resonance frequency ω₀, wherein the resonance frequency ω₀ is given by

$${ω}_{0} = \frac{4 π δ}{A} \sqrt{\frac{E}{ρ ( 1 - {ϑ}^{2} )}} ,$$

wherein A is a pore size of support grid 118 spun by the membrane element 114, δ is a thickness of the membrane element 114, E an elastic modulus of the membrane element 114, ρ is a density of the membrane element 114 and ϑ is a Poisson ratio of the membrane element 114. The elastic modulus E of the membrane element 114 is ≥8 MPa. For frequencies below ω₀, the effective mass of the system is negative leading to high sound transmission loss at low frequencies. The resonance frequency ω₀ may be ≤5000 Hz, preferably ≤3000. The resonance frequency may be from 1000 Hz to 5000 Hz, preferably 1000 Hz to 3000 Hz.

FIG. 2 shows sound transmission loss curves of the sound insulation device 110, wherein sound transmission loss STL in dB as a function of frequency fin Hz is shown. Curve 122 shows experimental results using a honeycomb support element with cell diagonal length of 3 mm and 0.2 mm thick rubber membrane and curve 124 shows for this setup the numerical simulation results. In the experimental setup a loudspeaker was placed at a distance of 10 cm in front of the sound insulation device 110 and a microphone was placed at a distance of 10 cm behind the sound insulation device 110 for recording transmitted sound. The sound transmission loss curves show high values at a lower limit of frequency range, coming to a dip point at the resonance frequency, and increasing towards higher frequencies. The resonance frequency, in this embodiment at 932, separates the negative and positive effective density regions. This point represents a zero effective density where the membrane resonates resulting in the sound transmission loss dip. High sound transmission loss at the low frequency region is the result of negative density or negative effective mass.

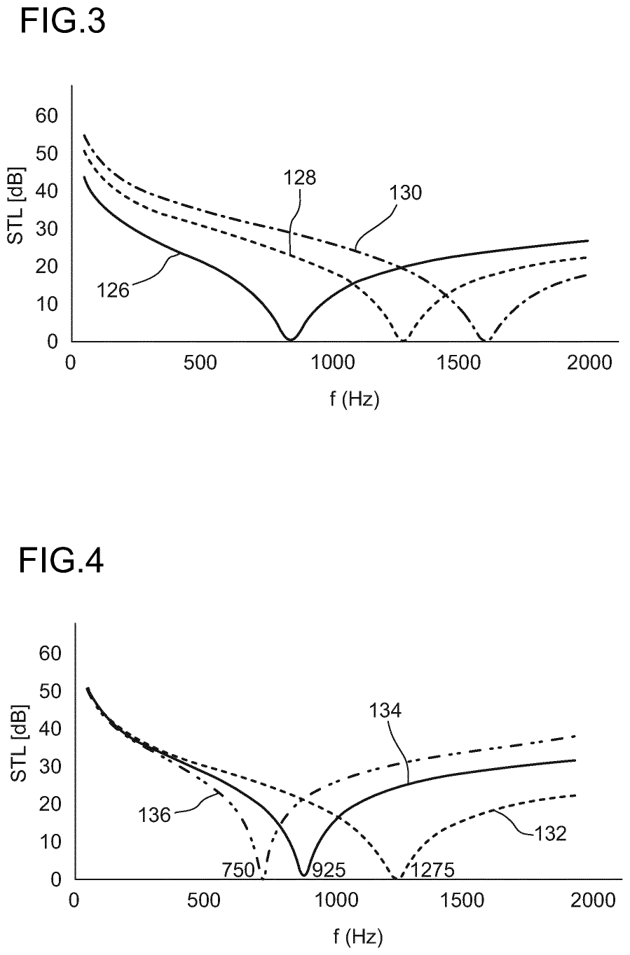

Preferably, the elastic modulus E of the membrane element 114≥8 MPa, preferably between 8 MPa and 25 MPa, preferably between 8.5 and 20 MPa for elongations up to 10%. FIG. 3 shows numerical simulation of the sound transmission loss of cell 120 on the sound insulation device for three values of elastic modulus E, specifically for 3 MPa (curve 126), 7 MPa (curve 128) and 11 MPa (curve 130). For this simulation the following membrane properties may be used: a membrane density of 1000 kg/m³, thickness 0.25 mm, and Poisson ratio of 0.49, assuming that the boundaries of the membrane element 114 are completely motionless. By increasing the elastic modulus the resonance frequency may be shifted towards higher frequencies.

Preferably, the density of the membrane element 114 may be in a range of 900 kg/m³≤ρ≤1200 kg/m³. FIG. 4 shows numerical simulation of the effect of membrane density on the sound transmission loss for three values of the density of the membrane element 114, namely for 1000 kg/m³ (curve 132), for 2000 kg/m³ (curve 134), for 3000 kg/m³ (curve 136). As the density increases the resonance frequency may be shifted towards higher frequencies, however, in expense of increased weight of the sound insulation device 110. Therefore, the membrane density may be towards a lower limit of an available material with the required elastic modulus.

Preferably, the thickness of the membrane element 114 may be in a range of 0.05≤δ≤1 mm, preferably 0.1≤δ≤0.5 mm, most preferably in a range of 0.20≤δ≤0.30 mm. However, the thickness increases the vibrating mass increases, too. The thickness may be selected such the vibrating mass is on the one hand not too big and on the other hand that the membrane element 114 is thick enough to avoid rupturing. Therefore, intermediate thickness of the membrane element 114 is preferred.

The support gird 118 may comprise a plurality of pores spun by the membrane element 114, wherein each of the pores may have a pore size A. The pore size A may be from 1 to 500 mm², preferably from 5 to 300 mm², most preferably from 10 to 100 mm². A proportion of the pores to the total area of the membrane element 114 may be from 50% to 95%, preferably from 60% to 90%, most preferably from 65% to 85%. Preferably, the Poisson ratio ϑ of the membrane element 114 may be in a range of 0.47≤ϑ≤0.50. Preferably, the membrane element 114 may have an ultimate elongation from 10 to 400%, preferably from 50 to 350%, more preferably from 100 to 300%.

FIGS. 6A to C show embodiments of cell geometry of cells 120. In FIG. 6A a triangular geometry is shown having an effective radius of

$$\frac{\frac{3}{4} {r}^{2}}{3 r} = \frac{r}{4} .$$

In FIG. 6B a square geometry is shown having an effective radius of

$$\frac{2 {r}^{2}}{4 r} = \frac{r}{2} .$$

In FIG. 6C a hexagonal geometry is shown having an effective radius of

$$\frac{\frac{\sqrt{3}}{4} {r}^{2}}{6 r} = \frac{r}{2 \sqrt{3}} .$$

Geometry of the support element 112 may affect resonance behavior of the membrane element 114. Preferably the cells 120 may have a square geometry, in particular in view of increase in blockage of noise energy. At the same time, solidity of the support element 112 may be of importance. In order to avoid side wise movement of the support element 112 and/or to have higher mechanical strength, a hexagonal mesh may be used. FIG. 6D demonstrates the effect of cell geometry on sound transmission loss of the sound insulation device 110 for equal cell perimeters for triangle (curve 136), hexagon (curve 138) and square (curve 140), wherein the sound transmission loss STL in dB as a function of frequency fin Hz is depicted. The simulation was based on a rubber membrane element 114 with thickness of 0.25 mm, density of 1000 kg/m3, elastic modulus of 7 MPa, and Poisson's ratio of 0.49.

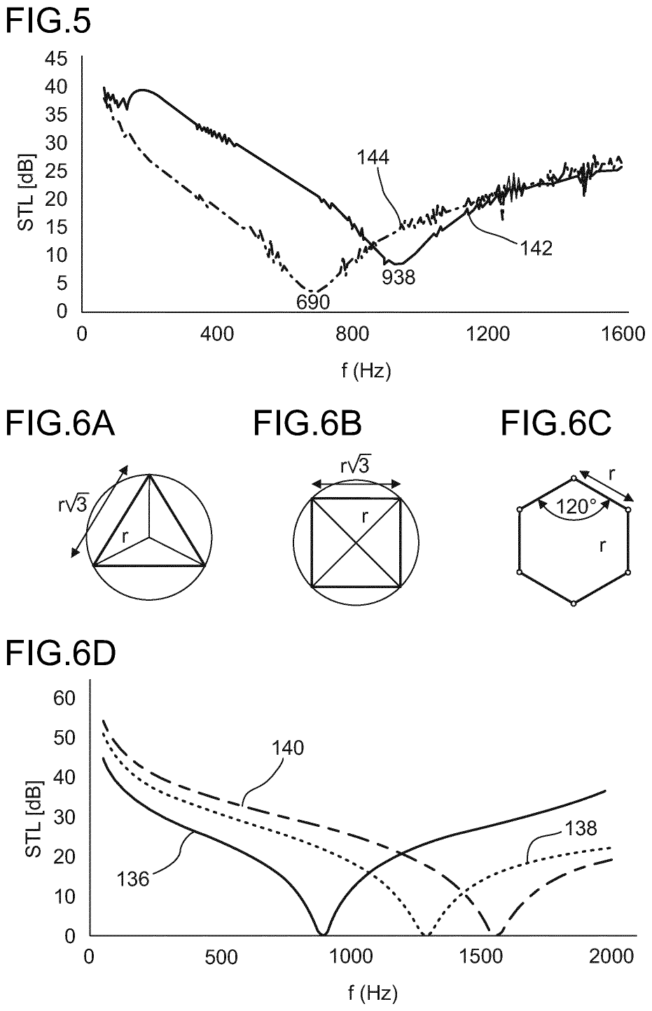

FIG. 5 shows an effect of cell size of cells 120 on sound transmission loss, wherein the sound transmission loss STL in dB as a function of frequency fin Hz is depicted. The cell size refers to the diagonal distance of the openings in the support grid 118. For FIG. 5 two honeycomb structures with cell diagonal length of 3 mm (curve 142) and 4.75 mm (curve 144) were tested with a 0.2 mm thick rubber membrane 114. Decreasing the size of the openings on the support grid 118 may increase the average sound transmission loss. A limiting factor may be the weight of the overall structure.

### LIST OF REFERENCE NUMBERS

110 sound insulation device

112 support element

114 membrane element

116 base element

118 support grid

120 Cell

122 Curve

124 Curve

126 Curve

128 Curve

130 Curve

132 Curve

134 Curve

136 Curve

138 Curve

140 Curve

142 Curve

144 Curve

1-14. (canceled)

15: A sound insulation device, comprising:
at least one rigid support element, and
at least one elastic membrane element,
wherein the at least one rigid support element comprises at least one support grid, wherein the at least one support grid comprises a plurality of cells, wherein the at least one elastic membrane element is arranged on the at least one support grid, wherein the at least one elastic membrane element comprises at least one thermoplastic polyurethane (TPU) membrane,
wherein the sound insulation device is configured to block at least partially acoustic energy transmission at a frequency range of 60 Hz to 500 Hz, wherein the sound insulation device exhibits a negative effective mass below a resonance frequency, wherein the resonance frequency is given by
$${ω}_{0} = \frac{4 π δ}{A} \sqrt{\frac{E}{ρ ( 1 - {ϑ}^{2} )}} ,$$
wherein A is a pore size of the at least one support grid spun by the at least one elastic membrane element, δ is a thickness of the at least one elastic membrane element, F an elastic modulus of the at least one elastic membrane element, ρ is a density of the at least one elastic membrane element and ϑ is a Poisson ratio of the at least one elastic membrane element, wherein the elastic modulus F of the at least one elastic membrane element is ≥8 MPa.

16: The sound insulation device according to claim 15, wherein the sound insulation device covers an area of greater than or equal to 0.5 m×0.5 m.

17: The sound insulation device according to claim 15, wherein the resonance frequency ω₀ is ≤5000 Hz.

18: The sound insulation device according to claim 15, wherein the pore size A of the at least one support grid spun by the at least one elastic membrane element is from 1 to 500 mm², wherein a proportion of pores to a total area of the at least one elastic membrane element is from 50 to 95%.

19: The sound insulation device according to claim 15, wherein the thickness of the at least one elastic membrane element is in a range of 0.05≤δ≤1 mm.

20: The sound insulation device according to claim 15, wherein the density of the at least one elastic membrane element is in a range of 900 kg/m³≤ρ≤1200 kg/m³.

21: The sound insulation device according to claim 15, wherein a geometry of the plurality of cells of the at least one support grid is selected from the group consisting of a triangle, a square, a circle, and a hexagon.

22: The sound insulation device according to claim 15, wherein the sound insulation device has a weight of 0.60 kg/m² or less.

23: The sound insulation device according to claim 15, wherein the at least one rigid support element further comprises at least one base element and/or at least one additional support grid.

24: The sound insulation device according to claim 23, wherein the at least one rigid support element further comprises at least one cover element comprising a further support grid having a further plurality of cells, wherein the at least one elastic membrane element is sandwiched between the at least one support grid and the at least one cover element.

25: The sound insulation device according to claim 24, wherein the at least one elastic membrane element is attached to the at least one support grid and/or the at least one cover element by at least one polyurethane based adhesive.

26: A method for manufacturing at least one sound insulation device according to claim 15, configured for blocking at least partially acoustic energy transmission at a frequency range of 60 Hz to 500 Hz, wherein the method comprises:
providing the at least one rigid support element;
providing the at least one elastic membrane element; and
attaching the at least one elastic membrane element to the at least one rigid support element;
wherein in an assembled state the sound insulation device exhibits a negative effective mass below the resonance frequency
$${ω}_{0} = \frac{4 π δ}{A} \sqrt{\frac{E}{ρ ( 1 - {ϑ}^{2} )}} .$$

27: An article comprising the sound insulation device according to claim 15, wherein the article is selected from the group consisting of a wall sound transmission loss panel; a noise protection installation next to a road, a track, or a fabrication unit; a sound blocking element in an electrical generator casing; a casing rotating elements; and a compressor of air conditioning casings.

28: The sound insulation device according to claim 16, wherein the sound insulation device covers an area greater than or equal to 1 m×1 m.

29: The sound insulation device according to claim 17, wherein the resonance frequency ω₀ is ≤3000 Hz.

30: The sound insulation device according to claim 18, wherein the pore size A of the at least one support grid is from 10 to 100 mm².

31: The sound insulation device according to claim 18, wherein the proportion of pores to the total area of the at least one elastic membrane element is from 65% to 85%.

32: The sound insulation device according to claim 19, wherein the thickness of the at least one elastic membrane element is in a range of 0.20≤δ≤0.30 mm.
